(19) United States
(12) Patent Application Publication
(10) Pub. No.: US 2009/0144741 A1
(43) Pub. Date: Jun. 4, 2009

(54) RESOURCE ALLOCATING METHOD, RESOURCE ALLOCATION PROGRAM, AND OPERATION MANAGING APPARATUS

(76) Inventors: Masahiko TSUDA, Yokohama (JP); Yasuhiro Takahashi, Kawasaki (JP)

Correspondence Address: MATTINGLY & MALUR, P.C., 1800 DIAGONAL ROAD, SUITE 370, ALEXANDRIA, VA, 22314, US

(21) Appl. No.: 12/043,544

(22) Filed: Mar. 6, 2008

(30) Foreign Application Priority Data
Nov. 30, 2007 (JP) 2007-311460

(51) Int. Cl. G06F 9/46

(52) U.S. Cl. 718/104

(57) ABSTRACT

An operation managing apparatus totalizes necessary resource amount information every the service so as to acquire necessary resource amount information every BP, and identifies the necessary resource amount information every the BP with resource amount information which can be utilized with respect to each of the service executing apparatuses so as to retrieve such service executing apparatuses capable of providing resource amounts by which the necessary resource amount information every the BP is stored. When the service executing apparatuses are retrieved, the operation managing apparatus allocates a service to the retrieved service executing apparatuses, whereas when the service executing apparatuses are not retrieved, the operation managing apparatus allocates the services to plural sets of the service executing apparatuses.

### BACKGROUND OF THE INVENTION

1. Field of the Invention

The present invention is related to a resource allocating method, a resource allocation program, and an operation managing apparatus.

2. Description of the Related Art

Virtual computer techniques have been utilized by which such an equivalent effect can be achieved that a resource of a physical computer is logically divided so as to utilize a plurality of computers. With employment of the above-described virtual computer techniques, business which has been conventionally carried out by individual physical computers is performed by virtual computers operated on a small number of the physical computers. As a result, a total number of these physical computers can be summed up. JP-A-2002-202959 has disclosed the technical idea capable of allocating the resources of the physical computers in response to the loads given to the virtual computers.

It should be understood that such a BP processing system has been proposed in which respective services which are executed by individual physical computers are called from activities defined by a BP (Business Process). The BP is described by a BPML (Business Process Modeling Language), and the like. Similarly, in the BP processing system, it is so required that since services called from BPs are executed by virtual computers, a total number of physical computers is summed up.

In the case that a conventional resource allocating method which does not consider such BPs is utilized with respect to the above-described BP processing system, reliability of the entire BP processing system is lowered, which constitutes a problem specific to the BP processing system. Concretely speaking, in such a case that services called from a certain BP have been allocated to resources while bridging a plurality of physical computers, if a failure happens to occur in one set of physical computer among these plural sets of physical computers, then the process operations for the entire BPs cannot be continuously carried out.

For instance, in a BP processing system, it is so assumed that there are physical computers “a1” and “a2”; a service “s1” is present which is executed by a virtual computer on the physical computer “a1”; and another service “s2” is present which is executed by a virtual computer on the physical computer “a2.” In such a case that there is a predetermined BP which calls both the services “s1” and “s2”, if a failure happens to occur in any one of these physical computers “a1” and “a2”, then the processing operation as to the predetermined BP cannot be continuously carried out. As previously described, the reason why the reliability is lowered is given as follows: That is, a total number of physical computers becomes large, while these physical computers allocate resources with respect to services called from the same BP.

### SUMMARY OF THE INVENTION

The present invention has been made to solve the above-described problem, and therefore, has a major object to provide such an inventive idea that services called from a BP are allocated to resources of physical computers in such a manner that reliability of a BP processing system may be improved.

To achieve the above-described object, a resource allocating method, according to an aspect of the present invention, is featured by such a resource allocating method executed in a BP (Business Process) processing system arranged by comprising: a BP executing apparatus for executing activities of BPs (Business Processes); a plurality of service executing apparatuses for executing services which are called by the activities; and an operation managing apparatus for managing resources of the service executing apparatuses, which correspond to resources of physical computers utilized by the services to be executed, wherein:

the operation managing apparatus reads out correspondence information between the activities of the BPs and the services called by the activities, necessary resource amount information for each of the called services, and resource amount information which can be utilized every the service executing apparatus from a storage unit;

the operation managing apparatus totalizes necessary resource amount information every the service so as to acquire necessary resource amount information every the BP, and identifies the necessary resource amount information every the BP with resource amount information which can be utilized with respect to each of the service executing apparatuses so as to retrieve such service executing apparatuses capable of providing resource amounts by which the necessary resource amount information every the BP is stored;

when the service executing apparatuses are retrieved, the operation managing apparatus allocates a service which is called from an activity belonging to the same BP with respect to a resource of one set of the service executing apparatus from the retrieved service executing apparatuses;

when the service executing apparatuses are not retrieved, the operation managing apparatus allocates the services to plural sets of the service executing apparatuses by repeatedly performing a process operation in which the operation managing apparatus selects the services called from the activities of the BPs in the order from a service having a larger necessary resource amount, selects the service executing apparatuses in the order from a service executing apparatus having a larger providable resource amount, and allocates the selected service to the selected service executing apparatus.

In accordance with the present invention, since the total number of the physical computers which execute the services called by the same BP can be minimized, the services called from the BP can be allocated to the resources of the physical computers in such a manner that the reliability of the BP processing system can be improved.

### BRIEF DESCRIPTION OF THE DRAWINGS

FIG. 1A and FIG. 1B are structural diagrams for indicating a BP processing system according to an embodiment of the present invention.

FIG. 2 is a structural diagram for showing a function of the BP processing system according to the embodiment of the present invention.

FIG. 3 is an explanatory diagram for explaining a method for allocating two sorts of services according to the embodiment of the present invention.

FIG. 4 is a flow chart for describing a resource allocating process operation according to the embodiment of the present invention.

FIG. 5 is a flow chart for describing a distributed allocation processing operation according to the embodiment of the present invention.

FIG. 6A and FIG. 6B are flow charts for showing re-allocating process operations of events (1) and (2), according to the embodiment of the present invention.

FIG. 7 is a flow chart for describing a re-allocating process operation of an event (3), according to the embodiment of the present invention.

FIG. 8A and FIG. 8B are explanatory diagrams for explaining a BP allocation structure before being changed, and a BP allocation structure after being changed, in accordance with the embodiment of the present invention.

FIG. 9 is an explanatory diagram for illustratively showing a screen which displays results obtained by allocating services to resources, in accordance with the embodiment of the present invention.

### DETAILED DESCRIPTION OF THE INVENTION

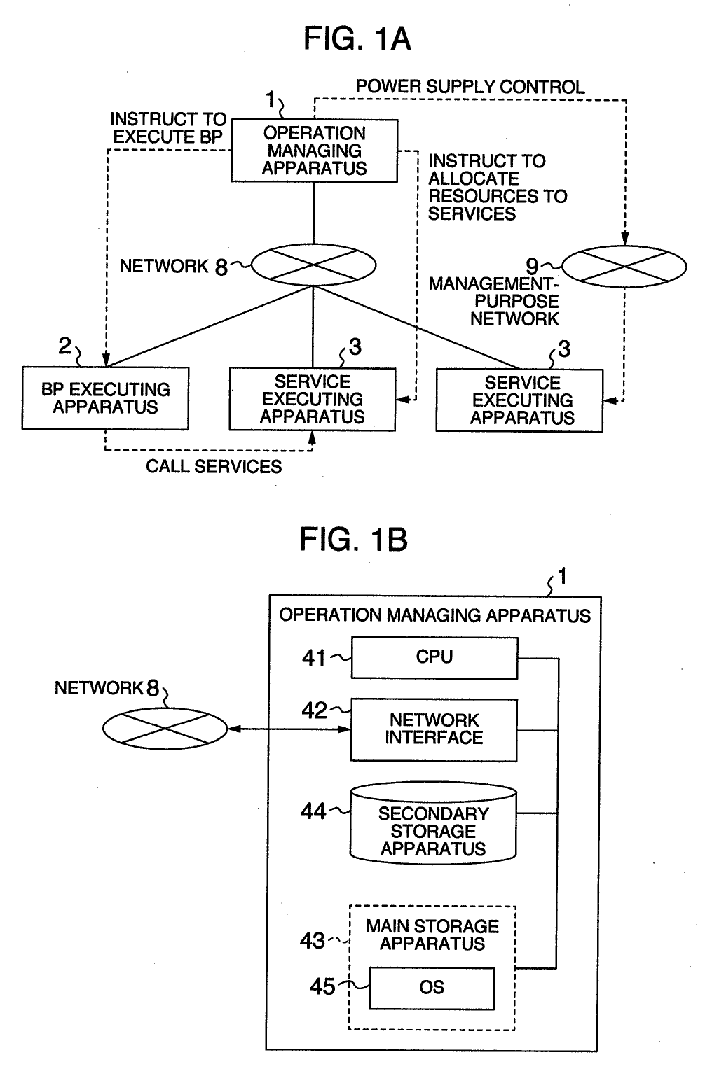

FIG. 1A shows a structural diagram of a BP (Business Process) processing system. The BP processing system is arranged in such a manner that one, or more sets of BP executing apparatus 2; one or more sets of operation managing apparatus 1; and two, or more sets of service executing apparatuses 3 are connected to each other via a network 8. The operation managing apparatus 1 instructs the BP executing apparatus 2 to execute a BP, and also, instructs the service executing apparatuses 3 to execute a service and to allocate a resource which is used by the instructed service. The above-described resource corresponds to a computer resource of the service executing apparatuses 3, and is defined based upon performance of a CPU, performance of a memory, and the like. A BP (Business Process) which is executed by the BP executing apparatus 2 calls a service which is executed by the service executing apparatuses 3.

In addition, the operation managing apparatus 1 is connected to the service executing apparatuses 3 by a management-purpose network 9 in order to control power supplies of the service executing apparatuses 3 from the operation managing apparatus 1. It should be understood that since sorts of data are different from each other which flow through the above-described network 8 and management-purpose network 9, it is desirable to separately prepare interfaces with respect to each of these networks 8 and 9 in the respective apparatuses which are connected to the respective networks 8 and 9, while these interfaces are employed so as to connect these apparatuses to the respective networks 8 and 9.

FIG. 1B is a structural diagram for representing a computer resource of the operation managing apparatus 1. The operation managing apparatus 1 which corresponds to a physical computer is provided with a CPU 41, a network interface 42, a main storage apparatus 43, and a secondary storage apparatus 44. The network interface 42 has been connected to the network 8. In the main storage apparatus 43, an OS (Operating System) 45 has been initiated, while the OS 45 performs such a control operation that respective processing units (will be described later) of the operation managing apparatus 1 are executed by the CPU 41. It should also be noted that similar to the operation managing apparatus 1, other apparatuses employed in the BP processing system are arranged as physical computers equipped with the respective computer resources shown in FIG. 1B.

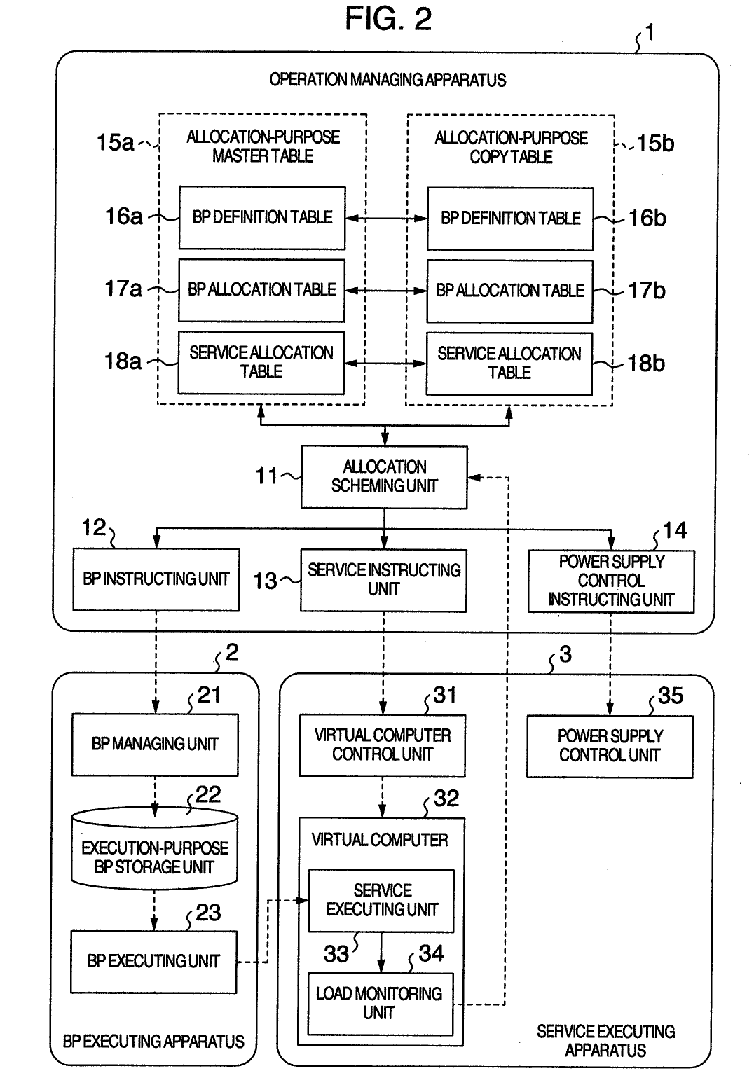

FIG. 2 is a structural diagram for indicating a function of the BP processing system. The operation managing apparatus 1 contains an allocation scheming unit 11, a BP instructing unit 12, a service instructing unit 13, and a power supply control instructing unit 14.

The allocation scheming unit 11 schemes a processing for allocating resources to a service by editing an allocation-purpose copy table 15b based upon a content of an allocation-purpose master table 15a.

The BP instructing unit 12 instructs the BP managing unit 21 via the network 8 to update a storage content of an execution-purpose BP storage unit 22 based upon contents of BP definition tables 16a and 16b.

The service instructing unit 13 instructs a virtual computer control unit 31 via the network 8 to allocate both services and resources on a virtual computer 32 based upon contents of BP allocation tables 17a and 17b, and also, contents of service allocation tables 18a and 18b.

The power supply control instructing unit 14 instructs the power supply control unit 35 via the management-purpose network 9 so as to turn ON/OFF the power supplies of the service executing apparatuses 3.

The operation managing apparatus 1 stores thereinto the allocation-purpose master table 15a and the allocation-purpose copy table 15b. The allocation-purpose master table 15a contains the BP definition table 16a, the BP allocation table 17a, and the service allocation table 18a. The allocation-purpose copy table 15b contains the BP definition table 16b, the BP allocation table 17b, and the service allocation table 18b. This allocation-purpose copy table 17b corresponds to such a copy formed from the allocation-purpose master table 15a, while an editing operation is performed with respect to this table copy. When an edited result is reflected under normal condition, the content of the allocation-purpose copy table 15b is reflected to the allocation-purpose master table 15a.

TABLE 1
BP definition tables 16a and 16b

| | | | | physical |
|---|---|---|---|---|
| | | | necessary | computer ID |
| BP | | | resource | of allocation |
| ID | activity ID | service ID | amount | destination |
| 1 | A1 | A | 10 | — |
| | B1 | B | 20 | — |
| | C1 | C | 10 | — |
| | D1 | D | 10 | — |
| | E1 | E | 10 | — |
| 2 | A2 | A | 10 | — |
| | F2 | F | 20 | — |
| | G2 | G | 20 | — |
| 3 | B3 | B | 20 | — |
| | H3 | H | 10 | — |
| | I3 | I | 20 | — |

The BP definition tables 16a and 16b represented in the above-described table 1 store thereinto BP IDs, activity IDs, service IDs, necessary resource amounts, and physical computer IDs of allocation destinations in correspondence with each other.

A symbol “BP ID” specifies a BP.

An activity ID specifies an activity which constitutes the BP of the BP ID.

A service ID specifies a service which is called from the activity of the activity ID.

A necessary resource amount is such a resource amount of a service executing apparatus 3 which is required in order to execute the service of the service ID.

A physical computer ID of an allocation destination specifies such a service executing apparatus 3 (namely, physical computer) to which the service of the service ID has been allocated.

TABLE 2
BP allocation tables 17a and 17b

| BP | necessary | | distributed |
|---|---|---|---|
| ID | resource amount | allocated flag | allocation flag |
| 1 | 60 | false | false |
| 2 | 50 | false | false |
| 3 | 50 | false | false |

The BP allocation tables 17a and 17b shown in the above-described table 2 manage sums of resources which are required in order to execute services called from the respective BPs.

A symbol “BP ID” corresponds to a main key of a record for specifying a BP.

A total resource amount is such a total of resources which are required so as to execute a service called from the BP indicated by the BP. This total resource amount is calculated by summing necessary resource amounts of records of the BP definition tables 16a and 16b, the BP IDs of which are identical to each other. For instance, in the case of BP ID=1, when “necessary resource amount (activity ID)” is expressed, “10(A1)”+“20(B1)”+“10(C1)”+“10(D1)”+“10(E1)”=60 becomes a total resource amount.

An allocated flag indicates such a flag for indicating whether a resource has been allocated (“true” indicative of a truth) with respect to the BP indicated by the BP ID, or not (“false” indicative of a falseness).

A distributed allocation flag indicates such a flag for representing whether the resources allocated to the BP indicated by the BP ID have been allocated to a plurality of physical computers in a distributed allocation manner (true: it is assumed as distributed allocation), or have been allocated to a single physical computer in a concentrated allocation manner (false: it is assumed as concentrated allocation).

TABLE 3
Service allocation tables 18a and 18b

| physical | resource | empty resource | |
|---|---|---|---|
| computer ID | amount | amount | service list |
| A | 100 | 60 | A (A1) |
| | | | A (A2) |
| | | | B (B1) |
| B | 100 | 80 | C (C1) |
| | | | H (H3) |
| C | 100 | 100 | |

The service allocation tables 18a and 18b indicated in the above-described table 3 store thereinto physical computer IDs, resource amounts, empty resource amounts, and service lists in correspondence with each other.

A physical computer ID specifies a service executing apparatus 3.

A resource amount indicates a total amount of resources which can be allocated in a physical computer having a physical computer ID.

An empty resource amount indicates a remaining resource amount which is calculated by subtracting an allocated resource amount from a total resource amount in the physical computer having the physical computer ID. For example, assuming now that a predetermined physical computer has a total resource amount of “100” and such a resource amount of “40” has already been allocated, an empty resource amount becomes “60.”

A service list is such a list about services which have already been allocated with respect to the physical computer having the physical computer ID. An expression “A(A1)” represents that a service “A” is called by an activity “A1.” For example, with respect to a physical computer “A”, services are indicated which are called by 3 pieces of activities “A1”, “A2”, and “A3”. A resource amount which is used by the services is calculated by that the resource amount “100”-the empty resource amount “60”=“40.”

The BP executing apparatus 2 has a BP managing unit 21, an execution-purpose BP storage unit 22, and a BP executing unit 23.

The BP managing unit 21 receives an instruction issued from the BP instructing unit 12 so as to update a storage content of the execution-purpose BP storage unit 22. The execution-purpose BP storage unit 22 stores thereinto combinations of activities which correspond to components for defining processing flows of a BP. In each of the activities, a service is called, a condition branching operation is performed, and the like.

The BP executing unit 23 calls a service in accordance with BP information of the execution-purpose BP storage unit 22.

The service executing apparatus 3 contains a virtual computer control unit 31, a virtual computer 32, and a power supply control unit 35. The virtual computer 32 contains a service executing unit 33 and a load monitoring unit 34.

Upon receipt of an instruction command issued from the service instructing unit 13, the virtual computer control unit 31 instructs the below-mentioned instruction contents with respect to the virtual computer 32:
The virtual computer control unit 31 allocates the service executing unit 33 to be executed.
The virtual computer control unit 31 allocates resources. An amount of the resources to be allocated may be freely set within a range which does not exceed resources held by the service executing apparatus 3.
The virtual computer control unit 31 acquires a used resource amount of the virtual computer 32.

The virtual computer 32 allocates from resources provided by the service executing apparatus 3, necessary resource amounts which are required in order to execute respective services which are called by an activity of a BP executed by the BP executing unit 23. Then, the virtual computer 32 initiates the service executing unit 33. It should also be noted that the resources which are provided for the service executing apparatus 3 by the virtual computer 32 may be unchanged (namely, fixed) with respect to an elapse of time, or may be alternatively changed.

The service executing unit 33 executes one, or more pieces of services by utilizing a resource which is allocated by the virtual computer 32.

The load monitoring unit 34 accesses the virtual computer control unit 31 in a periodic manner so as to monitor a load given to such a resource which has been allocated to a service under execution by the service executing unit 33.

Upon receipt of an instruction for turning ON/OFF a power supply issued from the power supply control instructing unit 14, the power supply control unit 35 controls the power supply of the service executing apparatus 3 corresponding to the own apparatus.

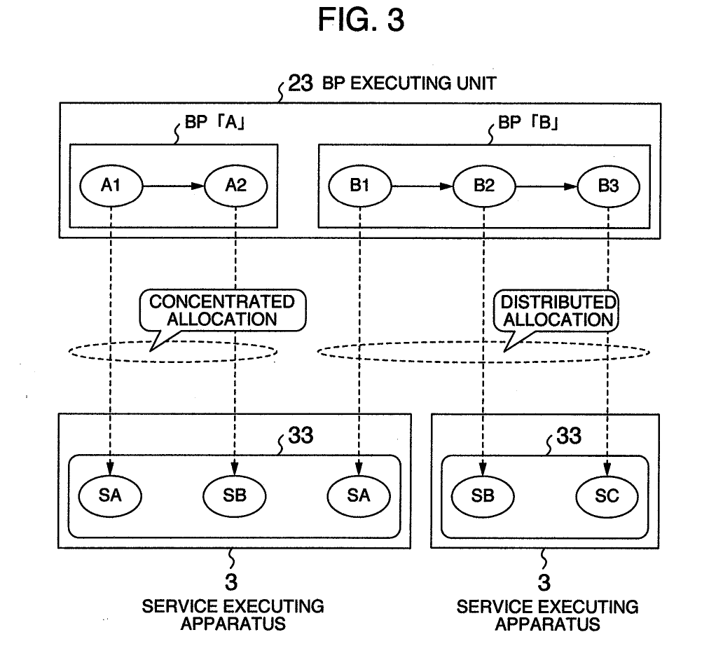

FIG. 3 is an explanatory diagram for explaining an allocating method of allocating 2 sorts of services. The BP executing unit 23 executes both BP “A” and BP “B.” The BP “A” is executed in this order of activities “A1”→“A2.” The BP “B” is executed in this order of activities “B1”→“B2”→“B3.” It should also be noted that as one example of the BPs, such a structure that the respective activities are executed in a predetermined sequence has been indicated, while a condition branching operation and the like are not provided. Alternatively, other structures may be employed in which processing operations are branched in a half way, or processing operations are executed in a parallel manner. The activity “A1” calls a service “SA” which is executed by the service executing unit 33 of the service executing apparatus 3.

Firstly, concentrated allocation indicates such an allocation that services which are called by all of activities belonging to a predetermined BP are allocated to a single service executing apparatus 3 in a concentrated allocation manner. For instance, since the activities “A1” and “A2” of the BP “A” call the services “SA” and “SB” which have been allocated to the same service executing apparatus 3, this service allocation corresponds to the concentrated allocation.

On the other hand, distributed allocation indicates such an allocation that services which are called by all of activities belonging to a predetermined BP are allocated to a plurality of service executing apparatuses 3 in a distributed allocation manner. For instance, since the activities “B1”, “B2”, “B3” of the BP “B” call both the service “SA” which has been allocated to a predetermined service executing apparatus 3, and the services “SB” and “SC” which have been allocated to another service executing apparatus 3, this service allocation corresponds to the distributed allocation.

In order to increase reliability of the BP processing system, this BP processing system must depend upon a small number of service executing apparatuses 3 as being permitted as possible. This reason is given as follows: That is, the larger a total number of these service executing apparatuses 3 is increased which depend upon the BP processing system, if even one set of service executing apparatus 3 among these plural service executing apparatuses 3 is brought into malfunction, then a BP cannot be executed. As a consequence, it is preferable to employ the concentrated allocation rather than the distributed allocation. Further, even when the allocation becomes the distributed allocation, it is desirable to reduce a total number of the service executing apparatuses 3 which depend upon the BP processing system as being permitted as possible.

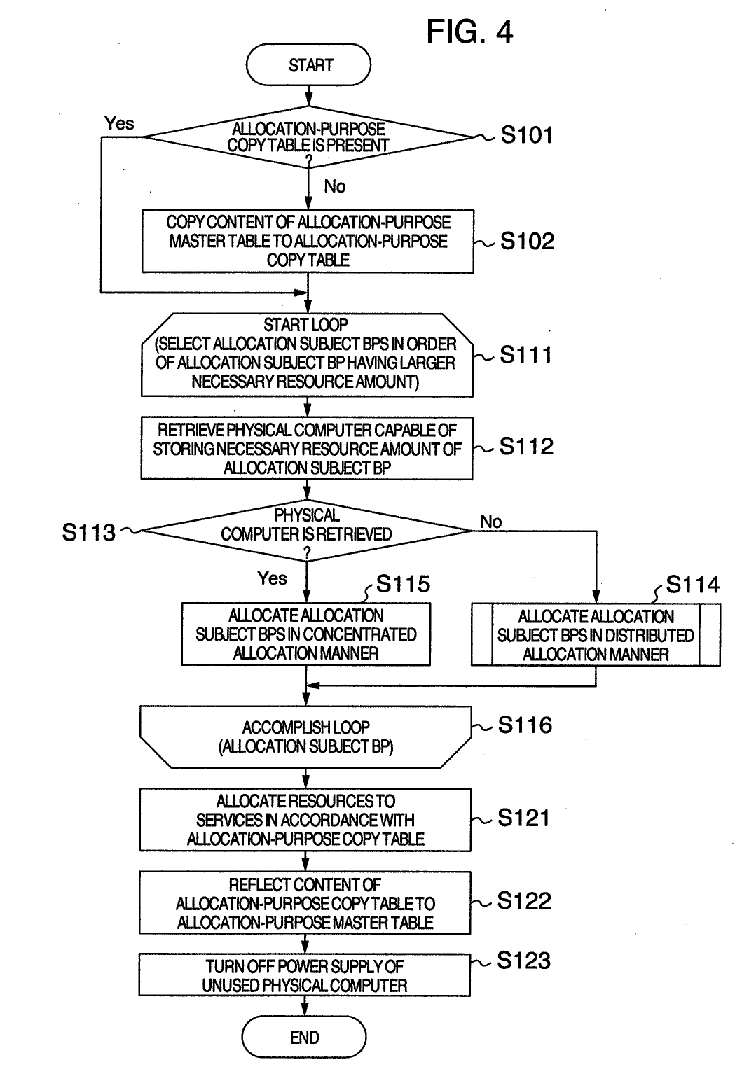

FIG. 4 is a flow chart for describing a resource allocating process operation which is executed by the allocation scheming unit 11.

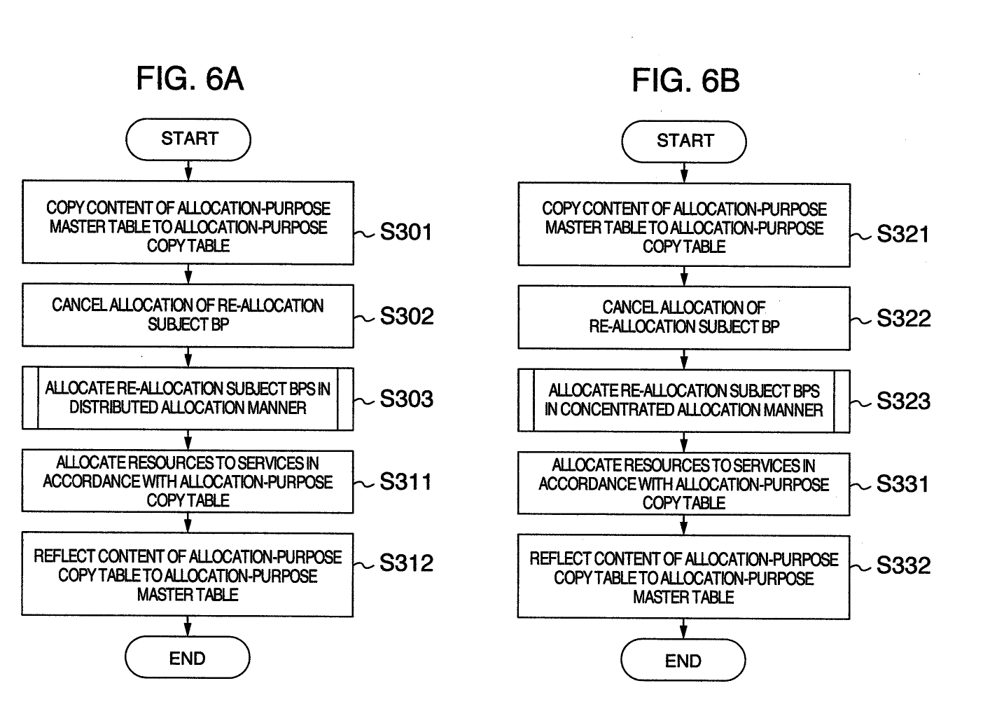

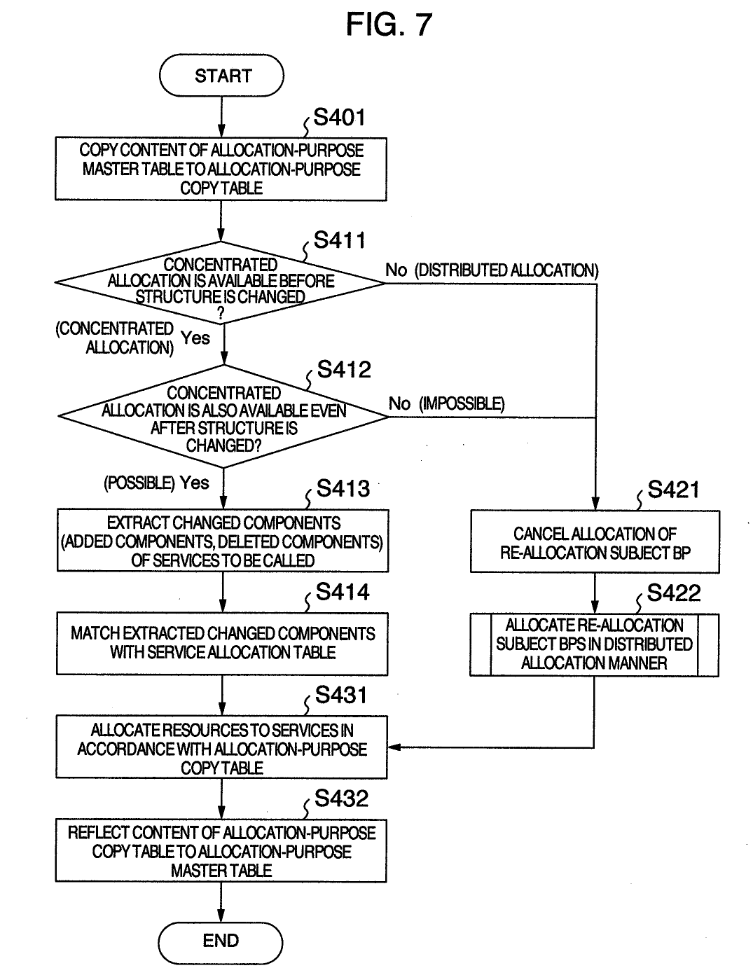

Firstly, when the allocation-purpose copy table 15b has not yet been formed (“No” in step S101), the content of the allocation-purpose master table 15a is copied to the allocation-purpose copy table 15b (step S102). Concretely speaking, the content of the BP definition table 16a is copied to the BP definition table 16b; the content of the BP allocation table 17a is copied to the BP allocation table 17b; and the content of the service allocation table 18a is copied to the service allocation table 18b, respectively. It should also be noted that a process operation when the allocation-purpose copy table 15b has already been formed (“Yes” in step S101) implies such a process operation that the allocation-purpose table 15b has already been formed as a preceding process operation before the flow chart of FIG. 4 is called from other process operations (indicated in either FIG. 6 or FIG. 7 which will be described later).

Next, the allocation scheming unit 11 refers to the BP allocation table 17b so as to execute a loop (defined from step S111 to step S116) which selects BPs as allocation subject BPs from a BPs to which resources have not yet been allocated in this order from a BP having a larger total resource amount. Since this loop is executed, an allocated flag of the allocation subject BP is updated from “false” to “true.” Since the BPs are allocated in this order from the BP having the larger total resource amount, it is possible to suppress that empty resources are segmented with respect to a plurality of physical computers.

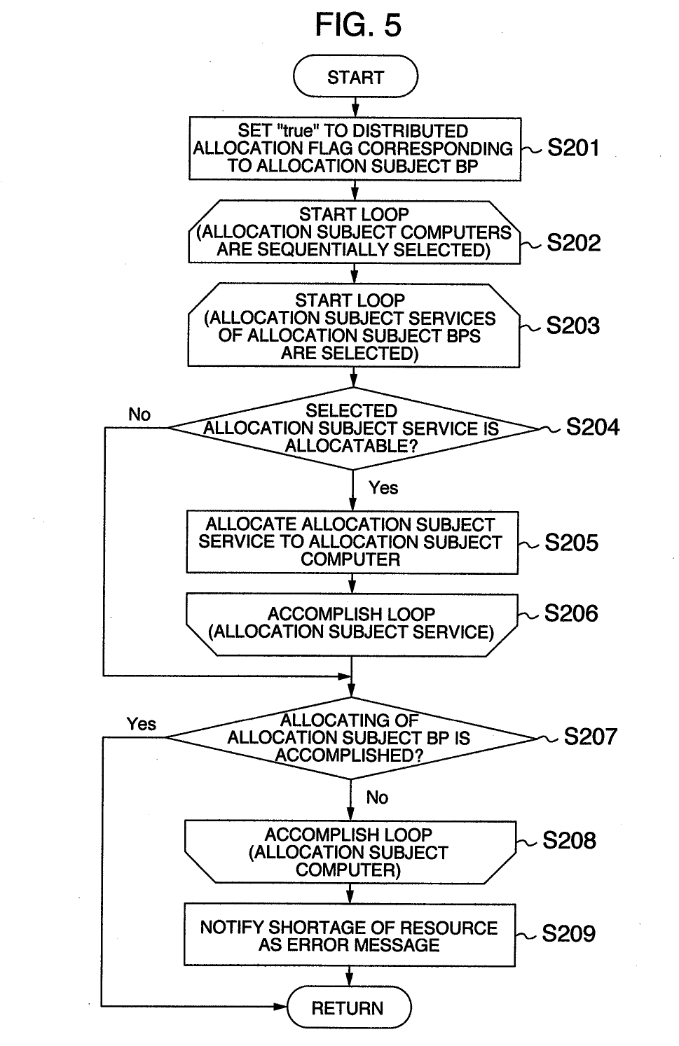

The allocation scheming unit 11 refers to the service allocation table 18b in order to retrieve a physical computer having an empty resource amount which exceeds a total resource amount of the allocation subject BPs (step S112). Firstly, as a result of the step S112, if the physical computer to which the allocation subject BPs can be allocated in the concentrated allocation manner is not retrieved (“No” in step S113), then the allocation subject BPs are allocated to a plurality of physical computers in the distributed allocation manner (step S114). Concretely speaking, a processing operation (will be described later) indicated in a flow chart of FIG. 5 is called as a subroutine.

On the other hand, as a result of the step S112, if one, or more sets of physical computers are retrieved (“Yes” in step S113), then the allocation subject BPs are allocated with respect to these retrieved physical computers in the concentrated allocation manner (step S115), and thereafter, the loop of the allocation subject BPs is accomplished (step S116).

Concretely speaking, with respect to the concentrated allocation (step S115), an allocation subject physical computer is specified from the retrieved physical computers in accordance with a predetermined policy (will be later explained in detail), and then, the allocation subject BPs are allocated to the specified allocation subject physical computer. In other words, an ID of the specified allocation subject physical computer is written into an ID column of allocation destination physical computers within a record which represents the allocation subject BPs of the BP definition table 16b. Thereafter, a list as to activities of the allocation subject BPs and services called by these activities is written in a service list column within a record of the service allocation table 18b, which indicates the specified allocation subject physical computer. Symbol “false” is set to a distributed allocation flag which corresponds to the allocation subject BP of the BP allocation table 17b.

In addition, in accordance with the content of the allocation-purpose copy table 15b updated in the above-described steps S114 and S115, the resources are allocated to the services (step S121). It should also be noted that this resource allocating process operation may be alternatively carried out after the content of the allocation-purpose copy table 15b is confirmed by a user and then a user permission is received. In order to realize allocating of the resources to the services, the service instructing unit 13 instructs the virtual computer 32 via the virtual computer control unit 31 to allocate the resources which will be used by the virtual computer 32, and further, initiates the service executing unit 33 so as to execute the allocated respective services by employing the allocated resources. It should also be understood that while the service executing unit 33 has already executed a service, if this service under execution is not present in the updated allocation-purpose copy table 15b, then such an allocation as to the above-described service and a resource which is used by this service is canceled.

Based upon the allocated result, the latest allocation status is reflected from the allocation-purpose copy table 15b to the allocation-purpose master table 15a (step S122). For instance, when all of the contents of the allocation-purpose copy table 15b have been allocated under normal condition, the contents of the allocation-purpose master table 15a become a copy of the allocation-purpose copy table 15b. On the other hand, when an allocation error (namely, step S209 of FIG. 5, will be discussed later) due to a lack of resources happens to occur in a portion of the contents of the allocation-purpose copy table 15b, a writing operation of such a content of the allocation-purpose copy table 15b, which has not been allocated due to the above-explained allocation error, is omitted with respect to the content of the allocation-purpose master table 15a. Then, since the allocation-purpose copy table 15b is no longer required, this allocation-purpose copy table 15b is deleted.

Next, a power supply of a physical computer which is not used is turned OFF (step S123). concretely speaking, the allocation scheming unit 11 refers to the service list of the service allocation table 18a so as to turn OFF the power supply of the physical computer to which the resources have not been allocated, so that the power control unit 35 executes a power saving operation. To this end, the power supply control instructing unit 14 instructs the power supply control unit 35 of the physical computer to which the resources have not been allocated via the management-purpose network 9 so as to turn OFF the power supply of this physical computer. As previously explained, the contents of the processing operations indicated in FIG. 4 have been mainly described.

It should be understood that the selection policy of the physical computer in the concentrated allocation (step S115) is realized by, for example, any one of the below-mentioned systems (1) and (2).

(1) A system for taking a stability in very seriously: A physical computer having a maximum empty resource is specified among retrieved physical computers. As a consequence, since empty resources of the respective physical computers are equalized, even when use amounts of resources are more or less increased/decreased, this amount change is absorbed by the empty resources, so that the stability of the BP processing system may be improved. In other words, even when a used amount of a resource temporarily exceeds an allocated resource amount, re-allocation of a resource can hardly occur. As a result, a total re-allocation time of the resources can be reduced.

(2) A system for taking power saving in very seriously: A physical computer having a minimum empty resource is specified among retrieved physical computers. As a consequence, resources are allocated to the specified computer in a concentrated allocation manner, so that other physical computers can be hardly used. As a result, since power supplies of these non-used physical computers are turned OFF, power saving effects can be emphasized.

Next, a description is made of concrete examples as to the service allocation table 18b in the respective selection policies. For the sake of a simple explanation, in service list columns described in the respective tables, instead of such service lists which have been originally stored, sums of resources are described which are required for the respective services belonging to these service lists. First of all, when numeral of “16” is described, services which are called by BPs have been allocated to a resource of a single physical computer in the concentrated allocation manner. In this case, this resource is such a resource whose resource amount is 16. On the other hand, when fractional numeral of “20/24” is described, services (namely, services whose total necessary resource amount is 24) which are called by BPs have been allocated to resources (namely, a resource whose resource amount is 20, and other resources) of plural sets of physical computers in the distributed allocation manner.

TABLE 4
(1) concentrated allocation by taking stability in
very seriously

| physical | resource | empty resource | |
|---|---|---|---|
| computer ID | amount | amount | service list |
| A | 20 | 4 | 16 |
| B | 20 | 6 | 14 |
| C | 20 | 3 | 12 |
| D | 20 | 6 | 10, 4 |
| E | 20 | 6 | 8, 6 |

The above-described table 4 represents such an example that the respective services which are called by the BPs in accordance with the system (1) have been allocated to a single physical computer.

That is, it is exemplified that BPs whose total necessary resources are 16, 14, 12, 10, 8, 6, and 4 are allocated with respect to physical computers A, B, C, D, and E, the resources of which are 20 respectively.

TABLE 5
(2) concentrated allocation by taking power saving in
very seriously

| physical | resource | empty resource | |
|---|---|---|---|
| computer ID | amount | amount | service list |
| A | 20 | 0 | 16, 4 |
| B | 20 | 0 | 14, 6 |
| C | 20 | 0 | 12, 8 |
| D | 20 | 10 | 10 |
| E | 20 | 20 | |

The above-described table 5 shows such an example that under the same condition as that of the table 4, the respective services which are called by the BPs in accordance with the system (2) have been allocated to a single physical computer. Comparing with the table 4, the resources are allocated to the physical computers A, B, C in the concentrated allocation manner, and conversely, the physical computer E has been brought into such a status that a resource is not used. As a result, the power supply of the physical computer E can be turned OFF.

TABLE 6
(1) distributed allocation by taking stability in very
seriously

| physical | resource | empty resource | |
|---|---|---|---|
| computer ID | amount | amount | service list |
| A | 20 | 0 | 20/24 |
| B | 20 | 16 | 4/24 |
| C | 20 | 0 | 20 |
| D | 20 | 4 | 16 |
| E | 20 | 8 | 12 |
| F | 20 | 12 | 8 |

The above-described table 6 shows such an example that a portion of the BPs has been allocated to a plurality of physical computers in accordance with the system (1). Namely, it is so exemplified that BPs whose total necessary resource are 24, 20, 16, 12, and 8 are allocated with respect to the physical computers A, B, C, D, and E, whose resources are 20 respectively. As to such a BP whose necessary resource is 24, the resource becomes short if only one physical computer is employed. As a result, the resources are allocated to 2 sets of the physical computers A and B which correspond to a minimum allocatable number of physical computers in the distributed allocation manner. As to other BPs, the resources are allocated from 1 piece of a physical computer.

TABLE 7
(2) distributed allocation by taking power saving in
very seriously

| physical | resource | empty resource | |
|---|---|---|---|
| computer ID | amount | amount | service list |
| A | 20 | 0 | 20/24 |
| B | 20 | 0 | 4/24, 16 |
| C | 20 | 0 | 20 |
| D | 20 | 0 | 12, 8 |
| E | 20 | 20 | |
| F | 20 | 20 | |

The above-described table 7 shows such an example that under the same condition as that of the table 6, a portion of the BPs has been allocated to a plurality of physical computers in accordance with the system (2). Comparing with the table 6, the resources are allocated to specific physical computers in the concentrated allocation manner, and conversely, the physical computers E and F do not use the resources. As a result, the power supplies of the physical computers E and F can be turned OFF. Moreover, physical computers which are used by each of the BPs are converged to 1 set to 2 sets thereof.

FIG. 5 is a flow chart for describing a process operation executed by the allocation scheming unit 11, in which designated allocation subject BPs are allocated to a small number of physical computers as being permitted as possible in a distributed allocation manner.

Firstly, the allocation scheming unit 11 sets “true” to a distributed allocation flag of the BP allocation table 17b, which corresponds to the allocation subject BPs (step S201). Since this flag setting operation is carried out, it is possible to grasp that the allocation subject BPs have been allocated in the distributed allocation manner.

Next, the allocation scheming unit 11 executes such a loop for selecting physical computers from the physical computers registered in the service allocation table 18b in this order from a physical computer having a larger empty resource amount as an allocation subject computer (steps S202 to S208).

Then, the allocation scheming unit 11 refers to the BP definition table 16b so as to execute such a loop for selecting unallocated subject services as allocation subject services from unallocated services among services which are called by the allocation subject BPs in this order of an unallocated service whose necessary resource amount is large (steps S203 to S206).

If an allocation subject service is allocatable to the allocation subject computer (“Yes” in step S204), then the allocation scheming unit 11 allocates the allocation subject service to the allocation subject computer (step S205). Concretely speaking, the allocation scheming unit 11 executes the below-mentioned process operations: That is, in the BP definition table 16b, a physical computer ID of the allocation subject computer is set to the allocation destination physical computer column of the allocation subject service. In the service allocation table 18b, the allocation subject service is added to the service list column, and a necessary resource amount of the allocation subject service is subtracted from the empty resource amount. On the other hand, if an allocation subject service cannot be allocated to the allocation subject computer (“No” in step S204), then the allocation scheming unit 11 breaks the loop of the allocation subject services, and thereafter, is advanced to a further step S207.

In this step S207, the allocation scheming unit 11 judges whether or not the allocation of the allocation subject BPs is accomplished. When the allocation of the allocation subject BPs is accomplished, this status indicates that all of the services called by the allocation subject BPs have been allocated by executing the allocating process operation defined in the step S205.

If the allocation of the allocation subject BPs is accomplished (“Yes” in step S207), since the allocation scheming unit 11 no longer executes the above-described loop of the allocation subject computer, the allocation scheming unit 11 breaks this loop, and then is returned from the subroutine of FIG. 5 to a calling source.

On the other hand, if the allocation of the allocation subject BPs has not yet been accomplished (“No” in step S207), then the execution of this loop is accomplished in order to change the allocation subject computer from the presently-considered allocation subject computer to another physical computer (step S208).

Then, when the loop (steps S202 to S208) of the allocation subject computers is accomplished, although all of these physical computers have been sequentially investigated, the allocation of the allocation subject BPs has not yet been accomplished. Accordingly, the allocation scheming unit 11 notifies such an error message that services cannot be executed due to a shortage of resources to both the user and the calling source (step S209).

TABLE 8

| | | event notifying | content of |
|---|---|---|---|
| | event content | method | re-allocation |
| 1 | loads given to | load monitoring | as to BP for calling |
| | services | unit monitors loads | services whose loads |
| | allocated in | given to services | are increased, |
| | concentrated | under execution by | allocation scheming |
| | allocation | service executing | unit once cancels |
| | manner are | unit, and when | concentrated |
| | increased, so | monitored load | allocation of this BP, |
| | that shortage | exceeds | and performs |
| | of resources | predetermined | distributed allocation |
| | for these | threshold value, | of this BP |
| | services | load monitoring | |
| | occurs | unit notifies this | |
| | | fact to allocation | |
| | | scheming unit | |
| 2 | loads given to | load monitoring | as to BP for calling |
| | distributed- | unit monitors loads | services whose loads |
| | allocated | given to services | are decreased, |
| | services are | under execution by | allocation scheming |
| | decreased, so | service executing | unit once cancels |
| | that resource | unit, and when | distributed allocation |
| | margin capable | monitored load | of this BP, and |
| | of performing | becomes lower than | performs concentrated |
| | concentrated | predetermined | allocation of this BP |
| | allocation | threshold value, | |
| | occurs | load monitoring | |
| | | unit notifies this | |
| | | fact to allocation | |
| | | scheming unit | |
| 3 | structural | BP instructing unit | allocation scheming |
| | change is | monitors content of | unit is tried to |
| | carried out | BP definition | additionally allocate |
| | with respect | table, and when | new service with |
| | to BP for | content thereof is | respect to previously- |
| | calling | updated, BP | allocated service |
| | service to | instructing unit | executing apparatus as |
| | which resource | notifies this | to service which is |
| | has been | updated content to | called by BP whose |
| | allocated | allocation scheming | structure has been |
| | | unit | changed. If new |
| | | | service cannot be |
| | | | allocated in |
| | | | concentrated |
| | | | allocation manner, |
| | | | then allocation |
| | | | scheming unit once |
| | | | cancels previously- |
| | | | allocated service and |
| | | | performs distributed |
| | | | allocation of this BP |

Next, a description is made of a sequential operation for re-allocating resources with respect to the BPs to which the resource allocation has been accomplished by executing the flow chart of FIG. 5 at such an opportunity when a predetermined event occurs. The above-described table 8 is a table for exemplifying 3 events as one example of the predetermined event. Events (1) and (2) indicate such invents which are caused by load variations of services, and another event (3) shows such an event which is caused by a structural change of a BP. The re-allocation of the resources is carried out only for a BP of an event subject (will be referred to as “re-allocation subject BP” hereinafter), and gives no specific influence to BPs other than this re-allocation subject BP.

It should also be understood that an opportunity for monitoring an event may be continuously established in a periodic manner, or may be alternatively established when an inquiry message sent from the operation managing apparatus 1 is received, otherwise may be made by receiving an instruction from a manager (namely, term defined from monitoring start instruction until monitoring end instruction is issued). Also, notification of an event monitored result may be omitted when a monitored value becomes the normal value, namely within a range of a threshold value, or the event monitored result may be alternatively notified even when the monitored value becomes the normal value.

FIG. 6A is a flow chart for describing a re-allocating process operation of the event (1), which is executed by the allocation scheming unit 11. Since this re-allocating process operation is carried out, a re-allocation subject BP in which a shortage of resource occurs can continuously execute a BP by utilizing a re-allocated resource.

Firstly, similar to the above-described step S102, the content of the allocation-purpose master table 15a is copied to the allocation-purpose copy table 15b (step S301). Then, as to a service called form the re-allocation subject BP, the allocation scheming unit 11 deletes information related to allocation from the allocation-purpose copy table 15b so as to cancel the allocation of the re-allocation subject BP (step S302). Concretely speaking, the allocation scheming unit 11 performs the following operations: That is, with respect to the re-allocation subject BP, the allocation destination physical computer column of the BP definition table 16b is made blank; the service called by the re-allocation subject BP is deleted from the service list column of the service allocation table 18b; and the allocated flag is returned from “true” to “false.” As a consequence, the service called from the re-allocation subject BP is returned to such a status that a resource has not yet been allocated.

Then, in order to execute allocation of the re-allocation subject BP in the distributed allocation manner (step S303), the allocation scheming unit 11 calls a subroutine of FIG. 5 while the re-allocation subject BP is defined as an allocation subject BP. Thereafter, the allocation scheming unit 11 performs the following process operations: That is, similar to the step S121, resources are allocated to services in accordance with the updated content of the allocation-purpose copy table 15b (step S311). Similar to the step S122, the latest allocation status is reflected from the allocation-purpose copy table 15b to the allocation-purpose master table 15a based upon the allocated result (step S312).

FIG. 6B is a flow chart for describing a re-allocating process operation of the event (2), which is executed by the allocation scheming unit 11. Since this re-allocating process operation is carried out, re-allocation subject BPs which have been allocated in the distributed allocation manner are allocated in the concentrated allocation manner, so that reliability may be improved.

Each of processing operations indicated in FIG. 6B is equivalent to each of those shown in FIG. 6A. That is to say, the step S301 corresponds to a step S321; the step S302 corresponds to a step S322; the step S303 corresponds to a step S323; the step S311 corresponds to a step S331; and the step S312 corresponds to a step S332, respectively.

A difference between the steps S303 and S323 is given as follows: The re-allocation is carried out in either the distributed allocation manner (step S303) or the concentrated allocation manner (step S323). In other words, in the step S323, the processing operation of FIG. 4 is called instead of calling of the subroutine shown in FIG. 5. It should be understood that the forming process operation of the allocation-purpose copy table 15b is omitted in the step S321 of FIG. 4 called after the allocation-purpose copy table 15b has been formed (“Yes” in step S101). Moreover, as to the policy conducted in the concentrated allocation (step S115) of FIG. 4, the system (1) for taking the stability in very seriously is preferably employed by which a total time of re-allocation can be reduced. Alternatively, the system (2) for taking the power saving in very seriously may be employed.

FIG. 7 is a flow chart for describing a re-allocating process operation of the event (3), which is executed by the allocation scheming unit 11. The re-allocating process operation shown in this flow chart is carried out when a row is added, or deleted with respect to an activity of a re-allocation subject BP of the BP definition table 16b.

Firstly, similar to the step S102, the allocation scheming unit 11 copies the content of the allocation-purpose master table 15a to the allocation-purpose copy table 15b (step S401).

Next, the allocation scheming unit 11 specifies whether the re-allocation subject BPs are allocated in the concentrated allocation manner, or in the distributed allocation manner with respect to services which are called by the re-allocation subject BPs. Concretely speaking, the re-allocation subject BPs have been allocated in the concentrated allocation manner before the structures thereof are changed by the distributed allocation flag of the BP allocation table 17b (“Yes” in step S411), and further, if the re-allocation subject BPs whose structures have been changed can also be additionally allocated with respect to the same physical computers to which the re-allocation subject BPs were allocated before the structures have been changed (“Yes” in step S412), then the re-allocation subject BPs are allocated in the concentrated allocation. On the other hand, if at least one of two conditions described in the steps S411 and S412 cannot be satisfied, then the re-allocation subject BPs are allocated in the distributed allocation manner.

In the case that the re-allocation subject BPs are allocated in the concentrated allocation manner (“Yes” in both steps S411 and S412), as to the re-allocation subject BPs, changed components (namely, addition components, or deletion components) about activities before/after being changed, and services called by these activities are extracted from the BP definition table 16b (step S413). Then, the service list column of the service allocation table 18b is matched with the services specified in the BP definition table 16b (step S414). In this case, with respect to the allocation definition physical computers for the services called by the re-allocation subject BPs, the deletion components of the services are deleted from the allocation-purpose copy table 15b, and the addition components of the services are added to the allocation-purpose copy table 15b.

In the case that the re-allocation subject BPs are allocated in the distributed allocation manner (“No” in any one of steps S411 and S412), the allocation scheming unit 11 cancels the allocation of the re-allocation subject BPs similar to the step S302, and allocates the re-allocation subject BPs similar to the step S303 (step S422).

Then, similar to the step S121, resources are allocated to the services in accordance with the updated content of the allocation copy table 15b (step S431). Similar to the step S122, the latest allocation status is reflected from the allocation-purpose copy table 15b to the allocation-purpose master table 15a based upon the allocated result (step S432).

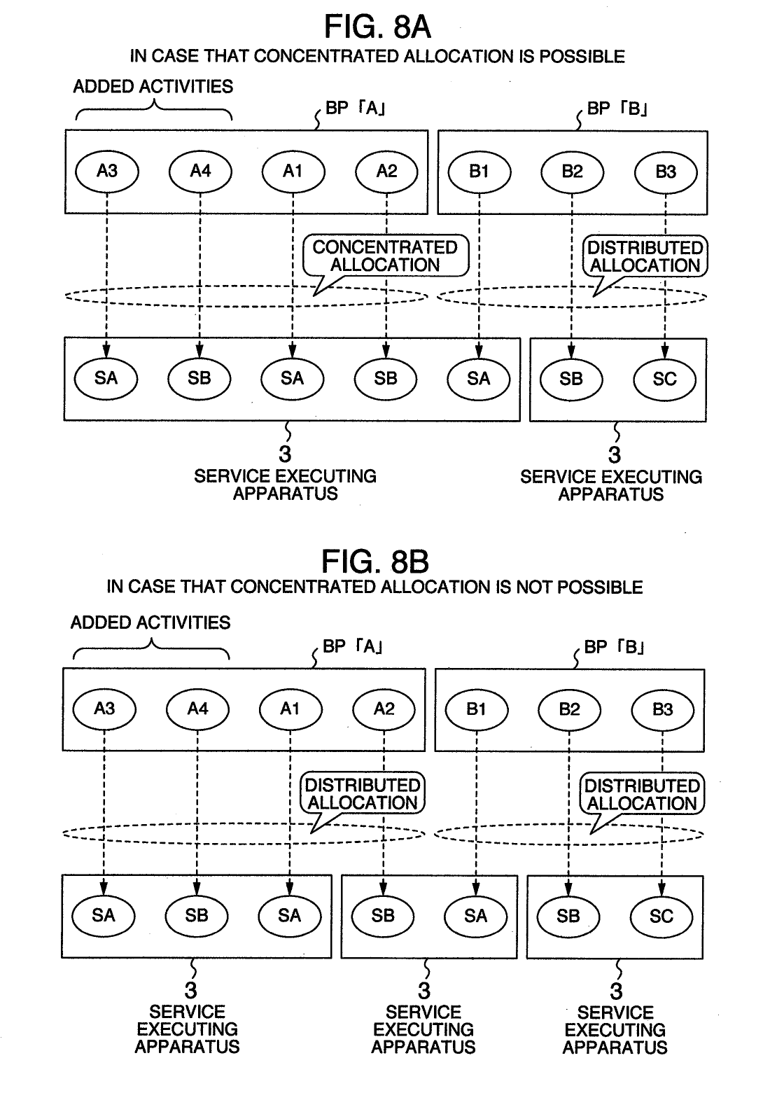

FIG. 8A and FIG. 8B are explanatory diagrams for explaining that BP structures have been changed for the allocation structures of the BPs before being changed, which are shown in FIG. 3. Since the BP structures have been changed, activities “A3, A4” have been added with respect to activities “A1, A2” which are called by the BP “A”. FIG. 8A indicates such an example that re-allocation subject BPs are allocated in the concentrated allocation manner, and FIG. 8B indicates such an example that re-allocation subject BPs are allocated in the distributed allocation manner.

First of all, in FIG. 8A, since the concentrated allocation is available (“Yes” in step S412), both the activities “A1, A2” to which the allocation has already been accomplished, and the activities “A3, A4” to which allocation is newly carried out utilize a resource provided on the same physical computer. As a consequence, services “SA” and “SB” which are called by the activities “A1, A2” need not cancel the allocation, but can continuously utilize the resource.

On the other hand, in FIG. 8B, since the concentrated allocation is not available (“No” in step S412), both the activities “A1, A2” to which the allocation has already been accomplished, and the activities “A3, A4” to which allocation is newly carried out utilize resources provided on the separate physical computers. As to services “SA” and “SB” which are called by the activities “A1, A2”, the allocation is once cancelled.

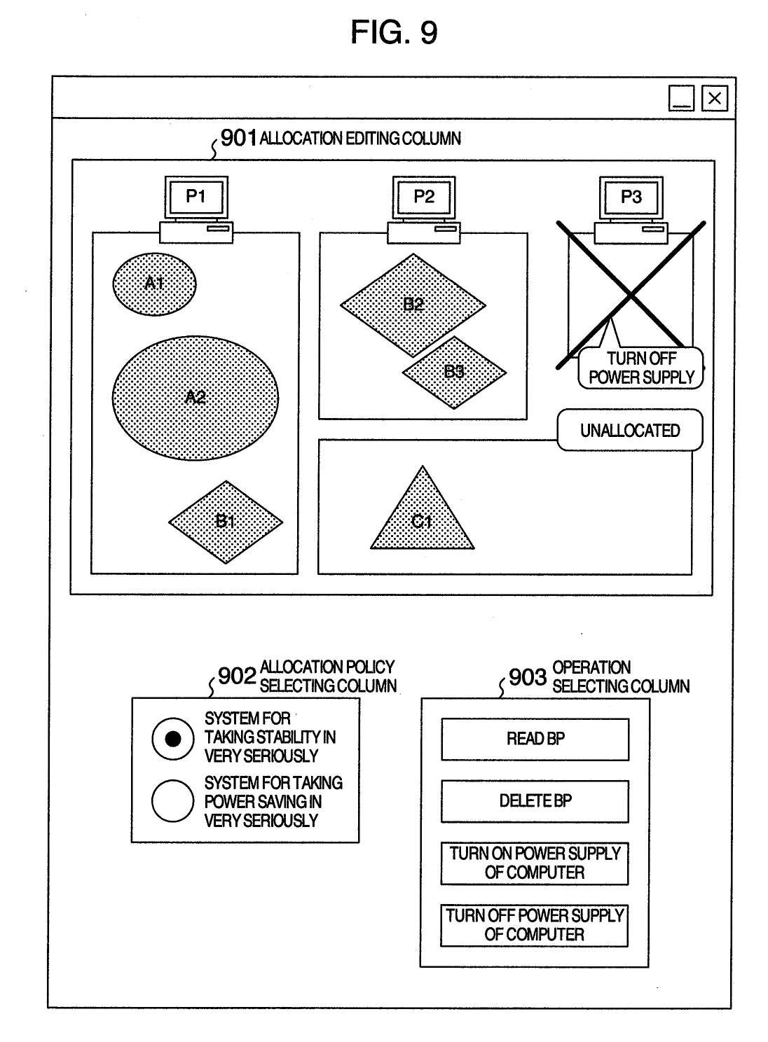

FIG. 9 is a diagram for illustratively showing a GUI (Graphical User Interface) screen which provides to a user, such a result that services have been allocated to resources. The screen diagram of FIG. 9 displays an allocation editing column 901, an allocation policy selecting column 902, and an operation selecting column 903 with respect to the user. Furthermore, this screen diagram accepts inputs from the user.

The allocation editing column 901 displays computer icons “P1, P2, P3” which represent the service executing apparatuses 3, and also displays activity icons “A1, A2, B1, B2, B3, C1.” Since these icons are clicked, a desirable icon may be selected. It should also be understood that since an activity has not been allocated to the computer icon “P3”, the power supply of the service executing apparatus 3 thereof has been turned OFF for the sake of power saving.

While resource rectangles have been set under the computer icons and dimensions of these resource rectangles are directly proportional to resource amounts contained by the relevant computers, activity icons arranged within these resource rectangles imply such activities which call services allocated to the relevant computers. On the other hand, an activity icon “C1” arranged within an “unallocated” rectangle indicates that this activity icon “C1” has not yet been allocated to the service executing apparatus 3. Since an unallocated activity icon is dragged and dropped into a resource rectangle, this unallocated activity icon may be allocated to the service executing apparatus 3 corresponding to the above-described resource rectangle.

Activity icons have shapes which are different from each other every belonging BP, and dimensions of these activity icons are directly proportional to necessary resource amounts of services to be called. For instance, since the activity icons “A1, A2, B1” have been allocated to the computer icon “P1”, there is a small empty space in the resource rectangle. Since the user views these activity icons A1, A2, B1, B2, B3, the user can intuitively grasp such a fact that BPs including the activity icons “A1, A2” have been allocated to the service executing apparatus 3 of the computer icon “P1” in the concentrated allocation manner, whereas BPs including the activity icons “B1, B2, B3” have been allocated to the separate service executing apparatuses 3 of the computer icons “P1 and P2” in the distributed allocation manner.

The allocation policy selecting column 902 exclusively selects any one of “system for taking stability in very seriously” and “system for taking power saving in very seriously.” The selected result is reflected onto the selection policy of the physical computers in the concentrated allocation manner (step S115).

In the operation selecting column 903, a button group for instructing that the allocation editing column 901 is edited has been arranged. Firstly, activities to be displayed in the allocation editing column 901 correspond to such activities that activities of previously edited BPs have been read (imported). It should also be noted that BP editing tools (not shown in this drawing, namely, text editor, exclusively-used GUI editor etc.) cause the user to edit an execution sequence of the respective activities contained in the BPs.

When a “BP reading” button is clicked, a dialog for selecting read subject BPs is displayed, and then, a BP selected via this dialog by the user becomes the read subject BP. Then, since the read subject BP (has been edited) is read, an activity icon of the read BP is displayed on the allocation editing column 901. It should also be noted that as to an activity of a newly-read BP, and another activity of a difference component between the activity of the newly-read BP and the activity of the edited/read BP during the previous time, activity icons thereof appear in the “unallocated” area.

When a “BP deleting” button is clicked, a list of the BPs read by clicking the “BP reading” button is displayed, and a BP which has been selected by the user from the list becomes a deletion subject BP. Then, since the deletion subject BP is deleted, an activity icon of this deletion subject BP is deleted from the allocation editing column 901. As another method for selecting the deletion subject BP, such a BP to which the activity of the activity icon selected from the allocation editing column 901 belongs may be alternatively defined as the deletion subject BP.

When a “computer power supply turn-ON” button is clicked after a computer icon has been selected from the allocation editing column 901, the power supply of the relevant computer is turned ON.

When a “computer power supply turn-OFF” button is clicked after a computer icon has been selected from the allocation editing column 901, the power supply of the relevant computer is turned OFF.

In accordance with the above-described present embodiment, as to services which are called by the same BP, resources of the same physical computer are allocated as being permitted as possible. As a result, while an adverse influence given to BP processing operations due to a failure of a physical computer can be suppressed to a minimum level, the reliability of the BP processing system can be improved. As a consequence, the present invention can suppress such a failure that when this failure happens to occur even in one physical computer among the plurality of physical computers, activities contained in the BPs can be no longer executed, so that the BP processing operation under execution is stopped at this stage.

It should be further understood by those skilled in the art that although the foregoing description has been made on embodiments of the invention, the invention is not limited thereto and various changes and modifications may be made without departing from the spirit of the invention and the scope of the appended claims.

1. A resource allocating method executed in a BP (Business Process) processing system arranged by comprising: a BP executing apparatus for executing activities of BPs (Business Processes); a plurality of service executing apparatuses for executing services which are called by said activities; and an operation managing apparatus for managing resources of said service executing apparatuses, which correspond to resources of physical computers utilized by said services to be executed, wherein:
said operation managing apparatus reads out correspondence information between the activities of the BPs and the services called by said activities, necessary resource amount information for each of the called services, and resource amount information which can be utilized every said service executing apparatus from a storage unit;
said operation managing apparatus totalizes necessary resource amount information every said service so as to acquire necessary resource amount information every said BP, and identifies the necessary resource amount information every said BP with resource amount information which can be utilized with respect to each of said service executing apparatuses so as to retrieve such service executing apparatuses capable of providing resource amounts by which the necessary resource amount information every said BP is stored;
when said service executing apparatuses are retrieved, the operation managing apparatus allocates a service which is called from an activity belonging to the same BP with respect to a resource of one set of said service executing apparatus from said retrieved service executing apparatuses;
when said service executing apparatuses are not retrieved, said operation managing apparatus allocates said services to plural sets of said service executing apparatuses by repeatedly performing a process operation in which the operation managing apparatus selects the services called from the activities of the BPs in the order from a service having a larger necessary resource amount, selects the service executing apparatuses in the order from a service executing apparatus having a larger providable resource amount, and allocates the selected service to the selected service executing apparatus.

2. A resource allocating method as claimed in claim 1 wherein:
in a step for allocating said services to one set of said service executing apparatuses, the services are allocated with respect to such a service executing apparatus whose providable resource amount is the largest resource amount among said retrieved service executing apparatuses.

3. A resource allocating method as claimed in claim 1 wherein:
in a step for allocating said services to one set of said service executing apparatuses, the services are allocated with respect to such a service executing apparatus whose providable resource amount is the smallest resource amount among said retrieved service executing apparatuses.

4. A resource allocating method as claimed in claim 1, wherein:
said operation managing apparatus further controls that a power supply of such a service executing apparatus is turned OFF to which the services have not been allocated as a result of the step for allocating said services.

5. A resource allocating method as claimed in claim 1 wherein:
when said operation managing apparatus further senses such an event that a load is increased which is given to the services allocated to one set of said service executing apparatus after a step for allocating said services, the operation managing apparatus once cancels the allocation as to the services called from the BP which calls the services whose load is increased, and thereafter, allocates the services with respect to the plural sets of said service executing apparatuses.

6. A resource allocating method as claimed in claim 1, wherein:
when said operation managing apparatus further senses such an event that a load is decreased which is given to the services allocated to plural sets of said service executing apparatuses after a step for allocating said services, the operation managing apparatus once cancels the allocation as to the services called from the BP which calls the services whose load is decreased, and thereafter, allocates the services with respect to one set of said service executing apparatus.

7. A resource allocating method as claimed in claim 1, wherein:
when said operation managing apparatus further senses that a structure of a BP has been changed which calls the allocated services after a step for allocating said services, said operation managing apparatus judges whether or not such a service which is called by an activity additionally provided due to the structural change can be allocated with respect to said service executing apparatus to which the services called by the structural-changed BP have been allocated;
if said service can be allocated thereto, then said operation managing apparatus adds the service called by the activity added with respect to said service executing apparatus;
if said service cannot be allocated thereto, then said operation managing apparatus once cancels the allocation of the services called by the structural-changed BP, and thereafter, allocates said services with respect to the plural sets of said service executing apparatus.

8. A resource allocation program for causing a computer to execute the resource allocating method recited in claim 1.

9. An operation managing apparatus employed in a BP (Business Process) processing system arranged by comprising: a BP executing apparatus for executing activities of BPs (Business Process); a plurality of service executing apparatuses for executing services which are called by said activities; and said operation managing apparatus for managing resources of said service executing apparatuses, which correspond to resources of physical computers utilized by said services to be executed, wherein:
said operation managing apparatus is comprised of:
a storage unit; and
an allocation scheming unit; and wherein:
said storage unit stores thereinto correspondence information between the activities of the BPs and the services called by said activities, necessary resource amount information for each of the called services, and resource amount information which can be utilized every said service executing apparatus;
said allocation scheming unit totalizes necessary resource amount information every said service so as to acquire necessary resource amount information every said BP, and identifies the necessary resource amount information every said BP with resource amount information which can be utilized with respect to each of said service executing apparatuses so as to retrieve such service executing apparatuses capable of providing resource amounts by which the necessary resource amount information every said BP is stored;
when said service executing apparatuses are retrieved, the allocation scheming unit allocates a service which is called from an activity belonging to the same BP with respect to a resource of one set of said service executing apparatus from said retrieved service executing apparatuses;
when said service executing apparatuses are not retrieved, said allocation scheming unit allocates said services to plural sets of said service executing apparatuses by repeatedly performing a process operation in which the allocation scheming unit selects the services called from the activities of the BPs in the order from a service having a larger necessary resource amount, selects the service executing apparatuses in the order from a service executing apparatus having a larger providable resource amount, and allocates the selected service to the selected service executing apparatus.
